(19) United States
(12) Patent Application Publication
(10) Pub. No.: US 2025/0099907 A1
(43) Pub. Date: Mar. 27, 2025

(54) HEAT AND MASS TRANSFER ASSEMBLIES

(71) Applicants: Alliance for Sustainable Energy, LLC, Golden, CO (US); Blue Frontier, Inc., Boca Raton, FL (US)

(72) Inventors: Eric KOZUBAL, Superior, CO (US); Matthew GRAHAM, West Palm Beach, FL (US); Daniel A. BETTS, Parkland, FL (US); Matthew TILGHMAN, Pennington, NJ (US); Chase CAMAROTTI, Oakland Park, FL (US); Gregory Matthias SHOUKAS, Denver, CO (US)

(21) Appl. No.: 18/891,157

(22) Filed: Sep. 20, 2024

Related U.S. Application Data
(60) Provisional application No. 63/584,433, filed on Sep. 21, 2023.

(51) Int. Cl. B01D 53/14; B01D 53/26; F28D 21/00

(52) U.S. Cl. CPC B01D 53/1425; B01D 53/263; F28D 21/0015; B01D 2257/80; B01D 2258/06; F28D 2021/0038

(57) ABSTRACT

The disclosure relates to heat and mass exchangers. In some examples, a heat-mass exchanger includes a plurality of regeneration fins extending generally vertically, and a plurality of desiccant feed tubes extending generally horizontally. The heat-mass exchanger also includes a plurality of regenerator heating tubes extending generally horizontally. The plurality of desiccant feed tubes are positioned above the plurality of regenerator heating tubes. In addition, the plurality of desiccant feed tubes and the plurality of regenerator heating tubes extend through the plurality of regeneration fins. Further, the plurality of desiccant feed tubes include feed tube openings adapted for delivering liquid desiccant onto surfaces of the plurality of regeneration fins.

### CROSS-REFERENCE TO RELATED APPLICATION

This application claims the benefit of priority to U.S. Provisional Patent Application No. 63/584,433, filed on Sep. 21, 2023, the entire disclosure of which is expressly incorporated herein by reference to its entirety.

### CONTRACTUAL ORIGIN

This invention was made with government support under Contract No. DE-AC36-08GO28308 awarded by the Department of Energy. The government has certain rights in this invention.

### TECHNICAL FIELD

The disclosure relates generally to heat and mass exchangers for heating, ventilation, and air conditioning systems and, more particularly, to heat and mass transfer assemblies for heat and mass exchangers.

### BACKGROUND

Heating, ventilation, and air conditioning (HVAC) systems generally cool ambient or room temperature air using a vapor compression refrigeration cycle. The HVAC systems may cool the ambient or room temperature air by removing heat using a refrigerant. Less frequently, the HVAC systems may employ a liquid desiccant to dehumidify the air during the cooling process. Further, the HVAC systems may include a heat exchanger that operates to remove the heat from the refrigerant. For example, the heat exchanger may include plates or coils through which the refrigerant flows. A fan may blow air across the plates or coils to cool the refrigerant flowing within.

### SUMMARY

According to some embodiments, a heat-mass exchanger includes a plurality of regeneration fins extending generally vertically, a plurality of desiccant feed tubes extending generally horizontally, and a plurality of regenerator heating tubes extending generally horizontally. The plurality of desiccant feed tubes and the plurality of regenerator heating tubes extend through the plurality of regeneration fins, where the plurality of desiccant feed tubes are positioned above the plurality of regenerator heating tubes. In addition, the plurality of desiccant feed tubes include feed tube openings adapted for delivering liquid desiccant onto surfaces of the plurality of regeneration fins.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description.

FIG. 1 illustrates a heat-mass exchanger, in accordance with some embodiments;

FIG. 2A illustrates portions of a heat-mass exchanger, in accordance with some embodiments;

FIG. 2B illustrates portions of a heat-mass exchanger, in accordance with some embodiments;

FIG. 2C illustrates portions of a heat-mass exchanger, in accordance with some embodiments;

FIG. 3 illustrates portions of a heat-mass exchanger, in accordance with some embodiments;

FIG. 4 illustrates evaporative media, in accordance with some embodiments;

FIG. 5 illustrates portions of a heat-mass exchanger, in accordance with some embodiments; and

FIG. 6 illustrates a heat-mass exchange system, in accordance with some embodiments.

### DETAILED DESCRIPTION

The following discussion omits or only briefly describes conventional features of heat and mass exchangers that are apparent to those skilled in the art. It is noted that various embodiments are described in detail with reference to the drawings, in which like reference numerals represent like parts and assemblies throughout the several views. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations.

Unless otherwise specifically defined herein, all terms are to be given their broadest reasonable interpretation including meanings implied from the specification as well as meanings understood by those skilled in the art and/or as defined in dictionaries, treatises, etc. It must also be noted that, as used in the specification and the appended claims, the singular forms “a,” “an” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. In the description, relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “above” versus “below,” “inwardly” versus “outwardly,” “longitudinal” versus “lateral,” and the like are to be interpreted relative to one another or relative to an axis of elongation, or an axis or center of rotation, as appropriate. Terms concerning attachments, coupling, and the like, such as “connected” and “interconnected,” refer to a relationship wherein structures are secured or attached to one another either directly or indirectly through intervening structures, as well as both movable or rigid attachments or relationships, unless expressly described otherwise. The terms “operatively connected,” “operably connected,” and the like are such attachments, couplings, or connections that allow the pertinent structures to operate as intended by virtue of that relationship.

Embodiments of the present disclosure relate generally to heat and mass exchangers and, more particularly, to heat and mass exchangers for liquid desiccant regeneration. For instance, in some examples, a heat and mass exchanger includes multiple regeneration fins (e.g., plates) extending along one direction (e.g., generally vertically). The heat and mass exchanger also includes multiple desiccant feed tubes that extend through the regeneration fins. The desiccant feed tubes can provide a flow of liquid desiccant (e.g., low concentration liquid desiccant) from, for instance, a conditioning system or a storage tank. Further, the heat and mass exchanger includes multiple regenerator heating tubes that also that extend through the regeneration fins. The regenerator heating tubes can provide a flow of heat transfer fluid (e.g., hot refrigerant from a vapor compression cycle loop or hot water from a waste heat recovery loop) e.g.. The desiccant feed tubes are positioned above the regenerator heating tubes as they extend through the regeneration fins.

Additionally, the desiccant feed tubes include feed tube openings (e.g., holes) adapted for delivering the liquid desiccant onto surfaces of the regeneration fins. For example, the liquid desiccant may proceed through the desiccant feed tubes and flow out of the desiccant feed tubes through the feed tube openings. As the liquid desiccant flows out of the feed tube openings, the liquid desiccant may flow down the surfaces of the regeneration fins. Heat may flow from the heat transfer fluid flowing through the regenerator heating tubes to the surface of the regeneration fins and then to the liquid desiccant, thereby evaporating water from the liquid desiccant and forming relatively higher concentration liquid desiccant. The liquid desiccant may be captured by a drain that is below the regeneration fins, and can be stored in a storage tank, for instance.

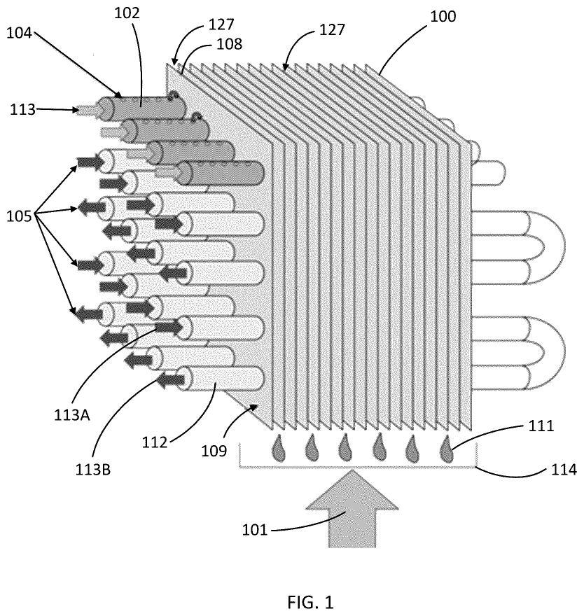

Referring to the drawings, FIG. 1 illustrates a heat-mass exchanger 100 that includes a plurality of regeneration fins 108, as well as a plurality of desiccant feed tubes 102 and a plurality of regenerator heating tubes 112 that extend through the plurality of regeneration fins 108. As illustrated, the plurality of regeneration fins 108 are positioned parallel to each other. In addition, in this example, the plurality of desiccant feed tubes 102 and the plurality of regenerator heating tubes 112 generally extend in a direction that is perpendicular to the direction in which the plurality of regeneration fins 108 extend. For instance, as illustrated, while the plurality of regeneration fins 108 generally extend generally in a vertical direction, the plurality of desiccant feed tubes 102 and the plurality of regenerator heating tubes 112 generally extend generally in a horizontal direction.

The plurality of regenerator heating tubes 112 may receive refrigerant 105 (e.g., hot refrigerant from a vapor compression cycle loop, such as hot refrigerant from a compressor of the vapor compression cycle loop), which flows through the plurality of regenerator heating tubes 112 as they extend through the plurality of regeneration fins 108 in a first direction. After proceeding across the plurality of regeneration fins 108 in the first direction 113A, each of the plurality of regenerator heating tubes 112 may direct the refrigerant 105 back towards the plurality of regeneration fins 108 in a second direction 113B that, in this example, is opposite the first direction 113A. e.g. Heat may flow from the refrigerant 105 to the plurality of regeneration fins 108 as the refrigerant 105 flows through the plurality of regenerator heating tubes 112, thereby removing heat from the refrigerant 105. The refrigerant 105 may then be provided back to the vapor compression cycle loop (e.g., an expansion valve or subcooler of the vapor compression cycle loop).

In addition, each of the plurality of desiccant feed tubes 102 may receive liquid desiccant 113 (e.g., diluted liquid desiccant from a liquid desiccant air conditioning (LDAC) system or dehumidifier), and may feed the liquid desiccant 113 through one or more feed tube openings 104. As the liquid desiccant 113 flows out from the feed tube openings 104, the liquid desiccant 113 is delivered to surfaces 109 of the plurality of regeneration fins 108. As such, the liquid desiccant 113 is distributed to regeneration channels 127 defined by adjacent regeneration fins 108. As described above, heat may flow from the refrigerant 105 to the plurality of regeneration fins 108. Heat may then flow from the plurality of regeneration fins 108 to the liquid desiccant 113 as the liquid desiccant 113 flows down the surfaces 109, thereby causing water from the liquid desiccant 113 to evaporate and generate relatively more concentrated liquid desiccant 111. A collector 114 may capture the concentrated liquid desiccant 111 which, as described further herein, can be provided to a storage tank.

Further, a regeneration airflow 101 may proceed counterflow (upward, in this example) to the liquid desiccant 113 proceeding along the surfaces 109 of the plurality of regeneration fins 108. The regeneration airflow 101 may be provided by a fan or blower, for example. The regeneration airflow 101 may flow within the regeneration channels 127 (e.g., regeneration fin 108 gaps), thereby removing heat from the plurality of regeneration fins 108 and transferring water vapor away from the regenerating liquid desiccant.

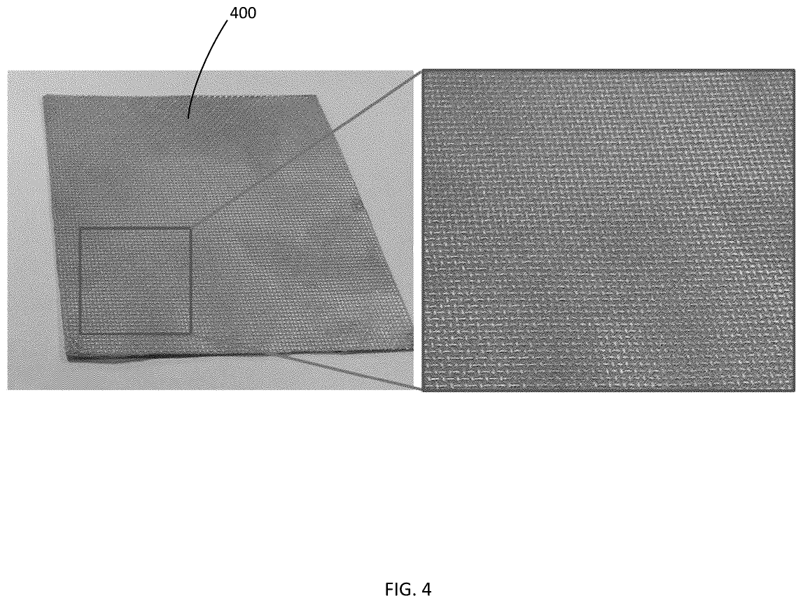

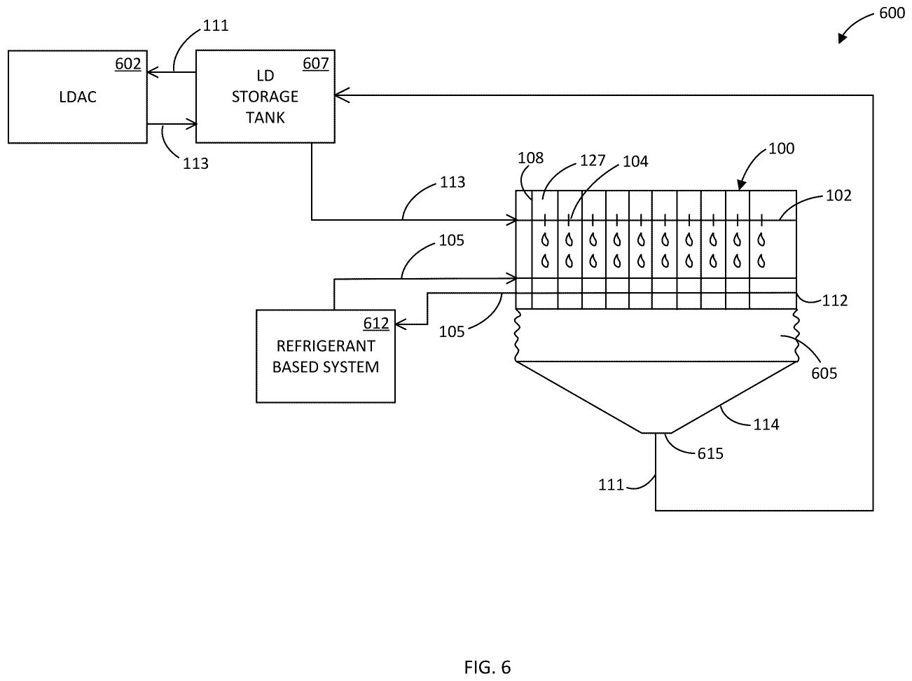

In some examples, as described herein, the surfaces 109 of the plurality of regeneration fins 108 are lined with wicking material (e.g., as described below with respect to FIGS. 4 and 6). The wicking material may be glued or bonded to the surfaces 109, for instance. Further, the wicking material may be, for instance, a metal woven mesh, plastic woven material, plastic non-woven material, or cellulosic non-woven material, among other examples. In some examples, the surfaces 109 are hydrophilic. For example, the surfaces 109 may be etched, or may include hydrophilic coatings, ceramic slip coating, surface treatments, or micro-scale features or nano-scale features. In some examples, the surfaces 109 include stamped or embossed features.

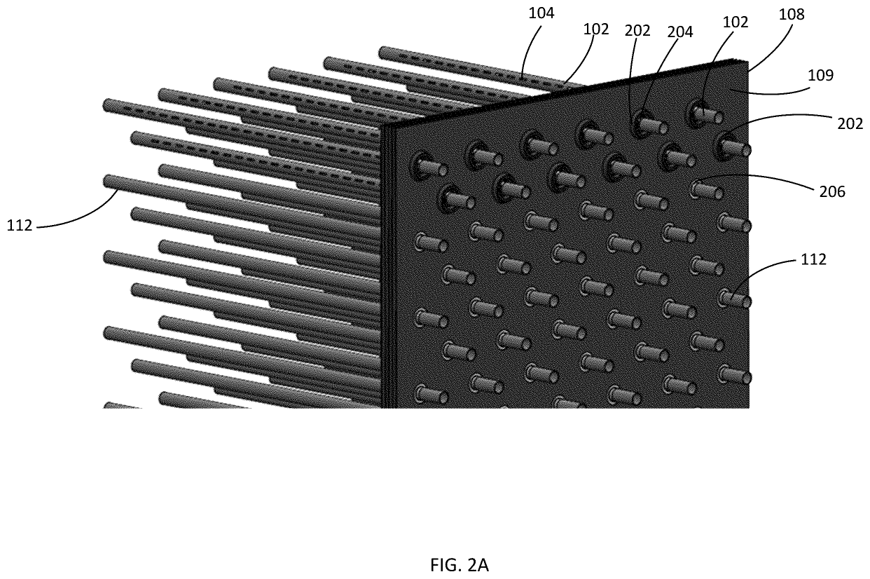

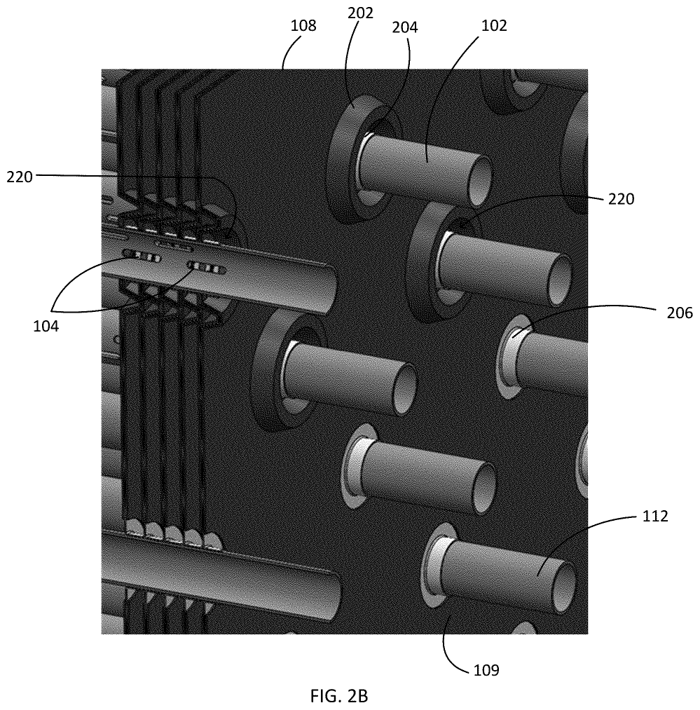

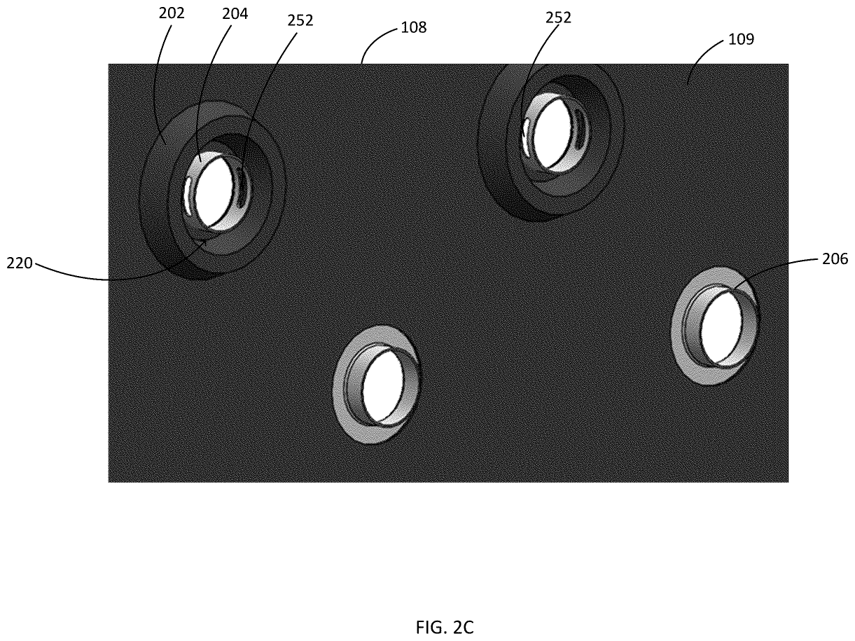

In some examples, the heat-mass exchanger 100 includes a plurality of retention structures through which the plurality of desiccant feed tubes 102 extend (e.g., as described with respect to FIGS. 2A, 2B, and 2C). The retention structures can include, for instance, O-rings, stamped features, or features coupled to a regeneration fin 108. Each of the plurality of retention structures is adapted to create a liquid desiccant distribution reservoir. For instance, one or more retention structures may be positioned within the regeneration channels 127 defined by opposite facing surfaces 109 of adjacent regeneration fins 108, and form a liquid desiccant distribution reservoir that can receive liquid desiccant 113 from one or more of the feed tube openings 104 of a corresponding desiccant feed tube 102. After flowing into the liquid desiccant distribution reservoir, the liquid desiccant 113 may flow out of the liquid desiccant distribution reservoir and onto the surfaces 109 of the adjacent regeneration fins 108. In some examples, as described herein, wicking material extends into the liquid desiccant distribution reservoir. A permeability of the wicking material allows the liquid desiccant 113 to flow out of the liquid desiccant distribution reservoir and onto the surfaces 109 of the adjacent regeneration fins 108.

In some examples, the plurality of regeneration fins 108 include collars through which the plurality of desiccant feed tubes 102 extend. Each collar may be configured to receive liquid desiccant 113 from one or more feed tube openings 104 of a corresponding desiccant feed tube 102. Further, the liquid desiccant 113 may flow from the collar and into a liquid desiccant distribution reservoir. For instance, each collar may include at least one collar opening, where the liquid desiccant 113 flows out of the collar openings and into the liquid desiccant distribution reservoir and/or the surfaces 109 of adjacent regeneration fins 108.

The plurality of regeneration fins 108 may have a predetermined fin density, such as 3 to 12 regeneration fins 108 per inch. In addition, the plurality of regeneration fins 108 may be made from metal (e.g., aluminum) or metal alloy (e.g., aluminum alloy), for instance. The plurality of desiccant feed tubes 102 and the plurality of regenerator heating tubes 112 may be made from metal, metal alloy, or plastic (e.g., polyvinyl chloride (PVC)).

FIGS. 2A, 2B, and 2C illustrate exemplary details of the heat-mass exchanger 100. As illustrated, a regeneration fin 108 includes a plurality of retention structures 202 through which a plurality of desiccant feed tubes 102 extend. For instance, each desiccant feed tube 102 may extend through an opening and a corresponding retention structure 202 of a regeneration fin 108. Each retention structure 202 may be stamped, embossed, or otherwise coupled to the surface 109 of the regeneration fin 108. The retention structures 202 may form a liquid desiccant distribution reservoir 220 for holding liquid desiccant 113 that is received from the feed tube openings 104 of a corresponding desiccant feed tube 102.

Further, each regeneration fin 108 may include a feed tube collar 204 through which a corresponding desiccant feed tube 102 extends. The feed tube collars 204 may be part of, or coupled (e.g., attached) to, the regeneration fins 108. Further, the feed tube collars 204 attach (e.g., secure) the desiccant feed tubes 102 to the regeneration fins 108. The feed tube collars 204 may include one or more collar openings 252, which may be aligned, at least partially, with a corresponding feed tube opening 104 of a desiccant feed tube 102. Thus, liquid desiccant 113 may flow out from a desiccant feed tube 102 through a feed tube opening 104 and a corresponding collar opening 252 into a liquid desiccant distribution reservoir 220 defined, at least in part, by a retention structure 202. As described herein, the liquid desiccant 113 may flow out of the liquid desiccant distribution reservoir 220 through wicking material (e.g., wicking material 302) that may extend into the liquid desiccant distribution reservoir 220.

The regeneration fins 108 may also include heating tube collars 206 through which the regenerator heating tubes 112 extend. The heating tube collars 206 may be part of, or coupled (e.g., attached) to, the regeneration fins 108. Further, the heating tube collars 206 attach (e.g., secure) the regenerator heating tubes 112 to the regeneration fins 108.

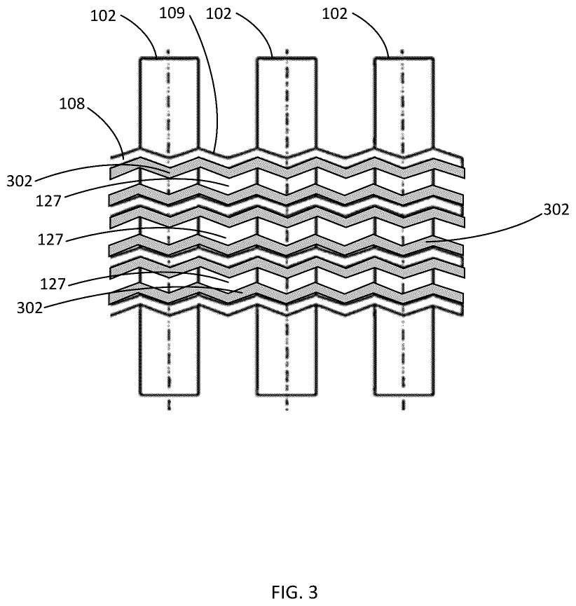

FIG. 3 illustrates desiccant feed tubes 102 extending through regeneration fins 108, where the regeneration fins 108 are wavy in shape. The wavy shape of the regeneration fins 108 may increase a surface area 109 of the regeneration fins 108, such as portions within the regeneration channels 127, as well as increase the path length of the flowing air (e.g., regeneration airflow 101). In addition, in this example, wicking material 302 (i.e., wicking media) is positioned along the surfaces 109 of the regeneration fins 108. The wicking material 302 may be, for instance, a metal woven mesh, plastic woven material, plastic non-woven material, or cellulosic non-woven material, among other examples. FIG. 4, for instance, illustrates a metal woven mesh 400 that may be adhered (e.g., glued, bonded) to a surface 109 of a regeneration fin 108. Referring back to FIG. 3, in some examples, the surfaces 109 of the regeneration fins 108 may, additionally or alternatively, include embossed or stamped features, which may increase surface 109 area, aid in liquid desiccant 113 wetting or break up regeneration airflow 101 boundary layers, or add turbulent mixing to the flowing air (e.g., regeneration airflow 101). In some examples, the surfaces 109 may be coated with a hydrophilic material to promote spreading of the liquid desiccant 113.

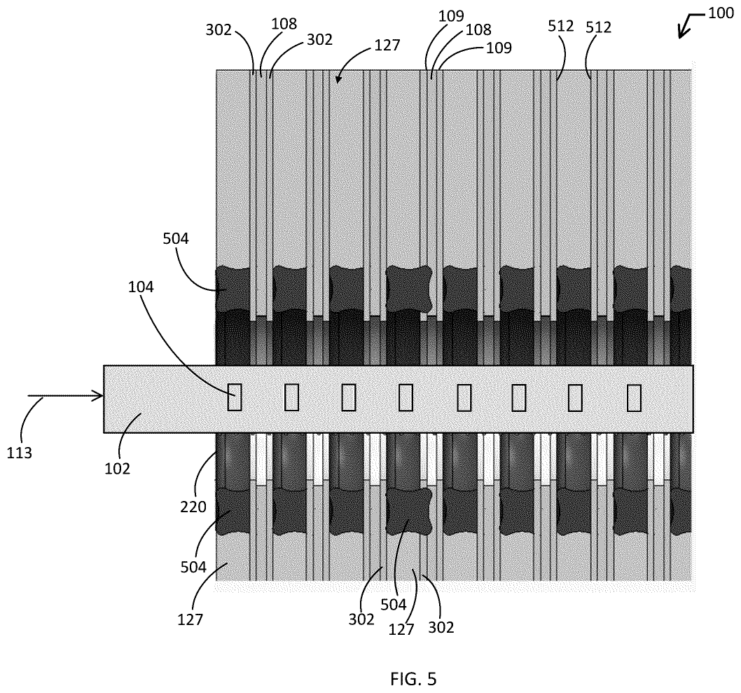

FIG. 5 illustrates a cross-sectional view of a heat-mass exchanger 100 that includes liquid desiccant distribution reservoirs 220 defined, at least in part, by O-rings 504 (e.g., rubber O-rings). In this example, wicking material 302 is positioned along the surfaces 109 of each regeneration fin 108. Further, an O-ring 504 is positioned between opposite facing surfaces 512 of wicking material 302. The liquid desiccant 113 proceeds through the desiccant feed tubes 102, and exits out of a plurality of feed tube openings 104 that coincide with corresponding liquid desiccant distribution reservoirs 220. Once in the liquid desiccant distribution reservoirs 220, the liquid desiccant 113 may flow through portions of wicking material 302 that extend into the respective liquid desiccant distribution reservoirs 220, and may continue to flow in a downwardly direction through the wicking material 302, thereby contacting the surfaces 109 of the regeneration fins 108.

FIG. 6 illustrates a heat-mass exchange system 600 that includes the heat-mass exchanger 100. The heat-mass exchange system 600 further includes a LDAC system 602, a liquid desiccant storage tank 607, and a refrigerant based system 612 that includes or is part of a vapor compression cycle loop. The LDAC system 602 may receive high concentration liquid desiccant 111 from the liquid desiccant storage tank 607 to dehumidify a flow of process air. After being used to dehumidify the flow of process air, the LDAC system 602 provides lower concentration liquid desiccant 113 to the liquid desiccant storage tank 607. The desiccant feed tubes 102 of the heat-mass exchanger 100 may receive the lower concentration liquid desiccant 113 from the liquid desiccant storage tank 607. In addition, the regenerator heating tubes 112 of the heat-mass exchanger 100 may receive a flow of hot refrigerant 105 from the refrigerant based system 612. Heat flows from the hot refrigerant as it flows through the regenerator heating tubes 112, and the now cooler refrigerant 105 is provided back to the refrigerant based system 612.

As described herein, the lower concentration liquid desiccant 113 may flow out of the desiccant feed tubes 102 through feed tube openings 104, and may then flow down within regeneration channels 127 defined by adjacent regeneration fins 108 of the heat-mass exchanger 100 (e.g., along the surfaces 109 of the regeneration fins 108). In addition, heat flows from the flow of hot refrigerant 105, through the regenerator heating tubes 112, and to the regeneration fins 108. The heat then flows from the regeneration fins 108 to the liquid desiccant 113 flowing along its surfaces 109, thereby evaporating water to generate relatively higher concentration liquid desiccant 111 (i.e., regenerating higher concentration liquid desiccant 111 from lower concentration liquid desiccant 113).

In this example, the higher concentration liquid desiccant 111 flows through evaporative media 605 (e.g., CELdek®) before being captured by the collector 114. The higher concentration liquid desiccant 111 may flow out of the collector 114 through a drain 615, and is provided to the liquid desiccant storage tank 607 for use by the LDAC system 602.

Among other advantages, the embodiments can provide a heat-mass exchanger that can regenerate liquid desiccant by heating low concentration liquid desiccant based on heat flowing from a hot heat transfer fluid, such as a hot refrigerant, to the low concentration liquid desiccant. For instance, in some examples, heat-mass exchanger includes a plurality of desiccant feed tubes and a plurality of regenerator heating tubes that extend through corresponding openings of a plurality of regeneration fins. The plurality of desiccant feed tubes are positioned above the plurality of regenerator heating tubes, and include feed tube openings that deliver liquid desiccant onto surfaces of the plurality of regeneration fins. For example, the plurality of desiccant feed tubes may receive low concentration liquid desiccant (e.g., used liquid desiccant) from a LDAC system, and may deliver the low concentration liquid desiccant to the feed tube openings.

Further, the low concentration liquid desiccant may flow out of the feed tube openings and into liquid desiccant reservoirs formed by retention structures on the surfaces of the plurality of regeneration fins. The low concentration liquid desiccant may flow out of the liquid desiccant reservoirs using wicking media that is aligned along the surfaces of the plurality of regeneration fins and extends into the liquid desiccant reservoirs. The liquid desiccant may then flow down through the wicking media and the surfaces of the plurality of regeneration fins. The plurality of regenerator heating tubes flow a hot refrigerant within (e.g., hot refrigerant received from a vapor compression cycle). Heat may flow from the hot refrigerant to the plurality of regenerator heating tubes, and then to the plurality of regeneration fins. As the liquid desiccant flows along the surfaces of the plurality of regeneration fins and the wicking media, heat flows to the liquid desiccant, thereby evaporating water and forming a relatively higher concentration liquid desiccant. A collector of the heat-mass exchanger may capture the higher concentration liquid desiccant, which may be provided to a storage tank for re-use by the LDAC system.

The various embodiments described above are provided by way of illustration only and should not be construed to limit the claims attached hereto. Those skilled in the art will readily recognize various modifications and changes that may be made without following the example embodiments and applications illustrated and described herein, and without departing from the spirit and scope of the following claims.

What is claimed is:

1. A heat-mass exchanger, comprising:
a plurality of regeneration fins extending generally vertically;
a plurality of desiccant feed tubes extending generally horizontally; and
a plurality of regenerator heating tubes extending generally horizontally,
wherein the plurality of desiccant feed tubes and the plurality of regenerator heating tubes extend through the plurality of regeneration fins,
wherein the plurality of desiccant feed tubes are positioned above the plurality of regenerator heating tubes, and
wherein the plurality of desiccant feed tubes include feed tube openings adapted for delivering liquid desiccant onto surfaces of the plurality of regeneration fins.

2. The heat-mass exchanger of claim 1 comprising a plurality of retention structures through which the plurality of desiccant feed tubes extend, wherein each of the plurality of retention structures is adapted to create a liquid desiccant distribution reservoir.

3. The heat-mass exchanger of claim 2, wherein the plurality of retention structures are adapted to receive the liquid desiccant from the feed tube openings of the plurality of desiccant feed tubes.

4. The heat-mass exchanger of claim 2, wherein wicking material extends into the liquid desiccant distribution reservoir.

5. The heat-mass exchanger of claim 4, wherein a permeability of the wicking material allows for a flow of the liquid desiccant out of the liquid desiccant distribution reservoir.

6. The heat-mass exchanger of claim 2, wherein the plurality of retention structures comprise O-rings sandwiched between pairs of the plurality of regeneration fins.

7. The heat-mass exchanger of claim 2, wherein the plurality of retention structures comprise stamped features along the surfaces of the plurality of regeneration fins.

8. The heat-mass exchanger of claim 1, wherein the plurality of regeneration fins comprise collars through which the plurality of desiccant feed tubes extend.

9. The heat-mass exchanger of claim 8, wherein each of the collars is configured to receive the liquid desiccant from at least one feed tube opening of a corresponding one of the plurality of desiccant feed tubes.

10. The heat-mass exchanger of claim 9, wherein each of the collars includes at least one collar opening, and wherein the at least one collar opening of each of the collars is adapted to feed the liquid desiccant to a corresponding surface of the plurality of regeneration fins.

11. The heat-mass exchanger of claim 1 comprising wicking material along the surfaces of the plurality of regeneration fins.

12. The heat-mass exchanger of claim 11, wherein the wicking material is configured to receive the liquid desiccant delivered from the feed tube openings of the plurality of desiccant feed tubes.

13. The heat-mass exchanger of claim 11, wherein the wicking material is comprised of at least one of: a metal woven mesh, plastic woven material, plastic non-woven material, and cellulosic non-woven material.

14. The heat-mass exchanger of claim 1, wherein the plurality of regeneration fins are parallel to each other.

15. The heat-mass exchanger of claim 1, wherein the plurality of regeneration fins are configured to receive a generally upward air flow for regeneration.

16. The heat-mass exchanger of claim 1 comprising a membrane separating an air flow from the plurality of regeneration fins.

17. The heat-mass exchanger of claim 1 comprising evaporative media below the plurality of regeneration fins.

18. The heat-mass exchanger of claim 1, wherein the plurality of regeneration fins are substantially perpendicular to the plurality of desiccant feed tubes and the plurality of regenerator heating tubes.

19. The heat-mass exchanger of claim 1, wherein the plurality of regeneration fins comprise hydrophilic surfaces.

20. The heat-mass exchanger of claim 19, wherein the hydrophilic surfaces are generated from at least one of: etching, ceramic slip coating, surface treatments, micro-scale features, and nano-scale features.

21. The heat-mass exchanger of claim 1, wherein the plurality of regeneration fins are wavy in shape.

22. The heat-mass exchanger of claim 1, wherein the surfaces of the plurality of regeneration fins include stamped or embossed features.
